(19) United States
(12) Patent Application Publication
(10) Pub. No.: US 2009/0212895 A1
(43) Pub. Date: Aug. 27, 2009

(54) Swinging Choke For Light Applications

(75) Inventors: Karl Gerhard, Breitenberg (DE); Walter Blaschke, Obernzell (DE); Dietmar Kropfmuller, Passau (DE)

Correspondence Address: BIRCH STEWART KOLASCH & BIRCH, PO BOX 747, FALLS CHURCH, VA, 22040-0747, US

(73) Assignee: VOGT ELECTRONIC COMPONENTS GMBH, OBERNZELL (DE)

(21) Appl. No.: 11/988,022

(22) PCT Filed: Jun. 29, 2006
(86) PCT No.: PCT/EP2006/006323

§ 371 Date: Apr. 22, 2009

(30) Foreign Application Priority Data
Jun. 29, 2005 (DE) 20 2005 010 234.2

(51) Int. Cl. H01F 17/00

(52) U.S. Cl. 336/178

(57) ABSTRACT

Swinging choke with a winding body, a core, which is integrated into the winding body such that the core forms at least one air gap in the winding body, at least one main winding which is wound onto the winding body, wherein the main winding is designed for a high voltage, and at least one ancillary winding the number of turns of which is designed such that a low voltage can be tapped and which is arranged above or close to the air gap.

The present invention relates to swinging chokes and in particular swinging chokes that can be used in electronic lamp ballasts for striking and operating lamps, such as fluorescent tubes or gas discharge lamps.

Such swinging chokes can be used to generate high-voltage pulses in an oscillating circuit for striking a lamp, such as fluorescent tubes, gas discharge lamps or electric arc lamps. The striking voltage can amount to several 1000 Voltₛₛ in the case of fluorescent tubes.

Swinging chokes suited for this purpose are described, for example, in the international patent application WO 03/007318 A2. Therein, a swinging choke with a symmetric double E core is disclosed.

In the operation of such lamps, it is desirable that at least one further voltage in the low-voltage range is available for one or several ancillary circuits. For example, it is desirable to heat at least one of the electrodes of the lamp to improve the efficiency and service life of the lamp. For heating, voltages in the range of typically 5 to 15 Volt are required which have to be relatively strictly kept as otherwise parts of the heating could be damaged, or the service life of the lamp could be reduced.

It is therefore an object of this invention to provide a swinging choke that on the one hand can be used for the striking circuit of a lamp and on the other hand reliably supplies voltage that can be used for an ancillary circuit, such as, for example a heating circuit. It is a further object of the invention to provide a driver for a lamp with a corresponding ancillary means, such as for example a heating means.

The object is achieved by a swinging choke with a winding body, a core that is integrated into the winding body such that the core forms an air gap in the winding body, at least one main winding that is wound on the winding body and designed for a high voltage, and at least one ancillary winding the number of turns of which is designed such that a low voltage can be tapped, said ancillary winding being arranged above or close to the air gap. Furthermore, the invention provides a driver for a lamp using such a swinging choke.

In detail, according to the preferred embodiment, a swinging choke with the following elements is provided:

a winding body that is subdivided into at least two winding chambers;

a two-part core, each partial core comprising an E-shaped cross-section with two legs of the same length, namely a first length h I, and a somewhat shorter central leg of a second length h2, and wherein the two-part core is integrated into the winding body such that the assembled double-E-core forms an air gap with the thickness d=(h1−h2)×2+a between the central legs of the partial cores if the front faces of opposite external legs comprise a balance distance a;

at least one main winding that is wound on the winding body and subdivided by the at least two winding clamps into a first main winding and a second main winding, the main winding being designed for high voltage, and

at least one ancillary winding which is arranged above the main winding in at least one winding clamp at or as close as possible to the air gap (10), and the number of turns of which is designed such that a low voltage can be tapped.

The ancillary winding permits the supply of an ancillary circuit, e.g. a heating device. As very high voltages can be applied to the main winding and the voltage at the ancillary winding should be comparably very low (e.g. in the range of 5 to 15 Volt), very few turns are required for the ancillary winding (1 to 5 turns). This results in the few turns of the ancillary winding having a large positioning margin in the winding chamber. As due to inhomogeneities of the core and to leakage fields the inductance of the ancillary winding highly depends on the position of the ancillary winding in the winding chamber, it is difficult, as concerns the manufacture, to provide an ancillary winding with defined inductance and thus with a defined tappable voltage in a reproducible manner.

According to the invention, however, it has been found that the inductance of the ancillary winding changes in the shape of a parabola with the distance to the air gap. This means that the positional dependence of the inductance is lowest in the proximity of the air gap. An arrangement of the ancillary winding as close as possible at or above the air gap therefore solves the problem of the large work tolerances and serial diffusion for a swinging choke with an ancillary winding.

In one embodiment of this invention, the winding body comprises a dividing wall whereby the winding body is subdivided into two winding chambers. The dividing wall is in this case arranged along the air gap so as to surround the same, such that the first and the second main windings each surround a central leg of one of the two E-shaped cores each, and the dividing wall surrounds the air gap.

A general advantage of the subdivision of the winding body into several winding chambers is that the so-called layer voltage can be kept low. If the number of turns for one winding layer is very high, due to the generally high voltage at the main winding and the voltage drop along the winding wire of a layer, the potential difference between two winding layers is very large, so that there arises the problem that an arcing within individual layers is possible due to the large potential difference. Due to the subdivision of the winding body into several winding chambers, the number of turns per layer can be kept low and the potential difference between two subsequent winding layers is correspondingly smaller.

Furthermore, the potential difference between the uppermost layer of the main winding in a winding chamber and the correctly arranged ancillary winding is correspondingly lower, so that the risk of an arcing between the main winding and the ancillary winding also becomes lower.

To reach a position of the ancillary winding in the proximity of the air gap, the ancillary winding is wound over the main winding in the first half, preferably in the first third, more preferred in the first fourth, and particularly preferred in the first eighth of the winding chamber on the side facing the dividing wall. As the dividing wall is arranged along the air gap, it is also possible to use the dividing wall as a stop for winding up the ancillary winding, so that the ancillary winding is located close to the air gap. Thereby, the precision and the reproducibility of the inductance are improved in the production.

In an alternative embodiment, the winding body can comprise two dividing walls subdividing the winding body into three winding chambers. The dividing walls are in this case arranged such that a central one of the three winding chambers is arranged along the air gap so as to surround the same. The ancillary winding is then wound onto the main winding in the central winding chamber.

The advantage of this arrangement is that the ancillary winding can be positioned more exactly above the air gap, and in the process an even lower positional dependence of the inductance can be achieved.

In an advantageous further development of the present invention, two ancillary windings are arranged symmetrically to the air gap and in direct proximity to the air gap.

Due to the symmetrical arrangement one obtains nearly equal inductances and nearly equal inductance drops during loading. Thereby, one also achieves a very low serial diffusion in production, and voltages as equal as possible can be tapped at the ancillary windings.

In one embodiment, the dimension of the thickness of the air gap is 1.4 mm. This dimension is suited for a swinging choke in a lamp ballast for striking and operating lamps.

In a further embodiment, the dividing wall has a thickness of 1.5 mm. This dimension, too, proved to be suited for a swinging choke to be used in a lamp ballast for striking and operating a lamp.

Preferably, this type of swinging chokes can be used in an electronic lamp ballast for striking and operating fluorescent tubes or gas discharge lamps.

In an advantageous further development, at least one of the electrodes of the above-mentioned lamps is heated via the voltage tapped at the ancillary winding. Thus, the service life of the lamp is improved.

In a further aspect of this invention, a driver for a lamp is provided which uses a swinging choke as it has been described above.

Below, various embodiments will be illustrated with reference to the accompanying drawings, wherein:

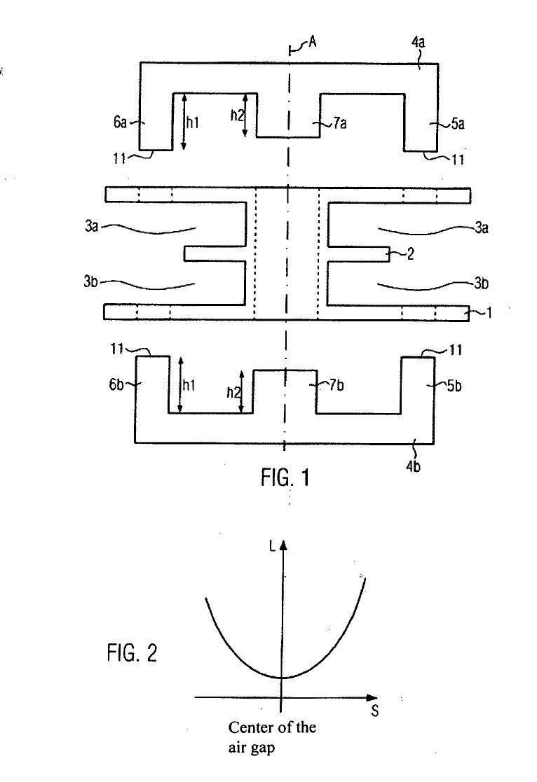

FIG. 1 shows a section through a winding body and a not yet integrated, two-part E-shaped core;

FIG. 2 shows an inductance-versus-distance diagram;

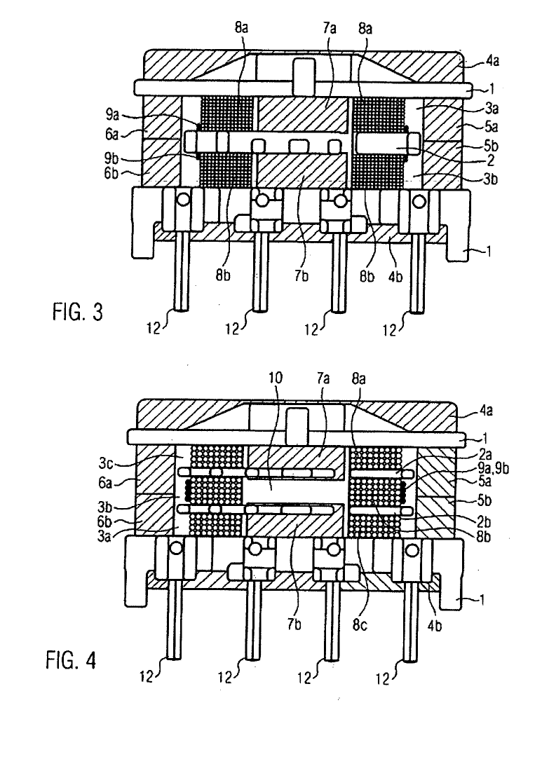

FIG. 3 shows a section through a swinging choke with two winding chambers; and

FIG. 4 shows a section through a swinging choke with three winding chambers.

FIG. 1 illustrates an embodiment of the present invention and shows a sectional view of a winding body 1 subdivided into two winding chambers 3a and 3b by a dividing wall 2. A two-part core 4a and 4b is represented in a separated state where the core 4a, 4b is not yet integrated into the winding body 1. Each partial core 4a, 4b has an E-shaped cross-section with two external legs 5a, 5b, 6a and 6b of the same length, namely length h1, and a somewhat shorter central leg 7a and 7b of the length h2. This is referred to as a symmetric double-E-core. However, other cross-sectional shapes are also possible. For example, the two-part core can be realized from two partial cores with a U-shaped cross-section, or from a partial core with a U-shaped cross-section and a partial core with an I-shaped cross-section. A double-L-core is also possible. The partial cores can be symmetrical or non-symmetrical. The winding body is not restricted to winding bodies with several winding chambers. Depending on the height of the operating voltage and the insulation of the winding wires, winding bodies with only one winding chamber are possible.

In one realization of the two-part core with a cross-sectional area each having an E-shape, the external legs 5a, 5b, 6a and 6b and the central legs 7a, 7b have a cuboid design. Corresponding to this embodiment of the core 4a, 4b, the winding body 1 can also have a cuboid-basic structure.

The winding body 1 is made of a non-metallic and non-conductive material or of a magnetically non-active material, preferably of plastics, with injection molding. However, other materials, such as for example ceramics, can also be used. The core 4a, 4b preferably contains a ferromagnetic material.

To obtain a swinging choke according to the invention according to the embodiment shown in FIG. 1, a main winding is applied in a first winding chamber 3a and subsequently in at least one second winding chamber 3b. Subsequently, at least one ancillary winding is wound so as to abut the dividing wall 2. Subsequently, the two parts of the two-part core 4a, 4b are inserted from opposite sides of the winding body 1. In some embodiments, the inductance of the winding is measured during the introduction of the two-part core, and the two partial cores 4a, 4b are inserted from opposite ends of the winding body until a predetermined inductance value is reached. Between the end faces 11 of the external legs 5a, 5b, 6a, 6b, a so-called balance distance a remains which can also take the value zero. The balance distance a is possibly filled with magnetically non-active material. For example, glass beads, possibly with a binder, such as silicone, can be used as filler. As the central legs 7a and 7b are shorter than the external legs 5a, 5b, 6a and 6b, an air gap 10 is formed with the thickness d=2×(h1−h2)+a between the central legs 7a, 7b of the partial cores 3a, 3b. In the embodiment which is shown in FIG. 1, the winding body 1 comprises an individual dividing wall 2 arranged along the air gap 10 so as to surround the same. As the ancillary winding has been wound so as to abut the dividing wall 2, the ancillary winding is as close as possible to the air gap, so that a very low serial diffusion of the production can be obtained and the ancillary windings are arranged symmetrically to the air gap and can thus emit a voltage as equal as possible.

The invention already shows its effects when the ancillary winding is wound over the main winding in the first third, preferably one fourth, most preferably one eighth of the winding chamber on the side facing the dividing wall (2).

FIG. 2 shows a diagram in which the inductance L is represented in response to the distance S in the axial direction with respect to a winding axis A between the air gap 10 and the ancillary winding 9. As can be seen in FIG. 2, the dependence of the inductance L of the distance has a parabolic course with the minimum of the parabola being in the center of the air gap. This means that the dependence of the inductance L of the distance is lowest at the air gap 10 as the gradient dL/da is zero at the summit of the parabola.

FIG. 3 shows a section through a technical embodiment of the swinging choke according to the invention, wherein the winding body 1 is subdivided into two winding chambers 3a and 3b by a dividing wall 2. Thereby, the main winding is subdivided into a first partial main winding 8a and a second partial main winding 8b. As can be seen in FIG. 3, two ancillary windings 9a and 9b are designed so as to be symmetrical to the air gap 10. Due to the fact that the dividing wall 2 is used as a stop for winding up the ancillary windings 9a, 9b, an arrangement of the ancillary windings 9a, 9b close to the air gap 10 and a symmetric orientation of the ancillary windings 9a and 9b to the air gap 10 are achieved. The embodiment shown in FIG. 3 also shows connection pins 12 which are connected with the winding wires. The connection pins 12 are integrated with the winding body 1 to form a base such that the winding axis A is arranged in parallel to the connection pins 12. However, the base can also be designed such that the connection pins 12 are arranged perpendicularly to the winding direction.

FIG. 4 shows a section through a technical realization of a swinging choke according to the invention, wherein the winding body 1 is subdivided into three winding chambers 3a, 3b and 3c by two dividing walls 2a and 2b. Thereby, the main winding is subdivided into a first partial main winding 8a, a second partial main winding 8b, and a third partial main winding 8c. The second partial main winding 8b is here arranged in the second (central) winding chamber 3b and encloses the air gap 10. The ancillary winding 9a, 9b is centrically wound in the central winding chamber 3b. As can be seen in FIG. 4, the ancillary windings 9 are arranged so as to be centred and symmetrical to the air gap 10 and permit an inductance that is particularly independent of the position, so that work tolerances and serial diffusion can be minimized. As in FIG. 3, the embodiment shown in FIG. 4 also shows connection pins 12 which are connected with the winding wires. The connection pins 12 are integrated with the winding body 1 to form a base such that the winding axis A is arranged in parallel to the connection pins 12. However, the base can also be designed such that the connection pins 12 are arranged perpendicularly to the winding direction.

The present invention was illustrated by way of example with reference to embodiments. However, the scope of the invention is not restricted to its embodiments as they have been described above, but it also extends to further developments which are within the frame of expert knowledge. The scope of the invention is therefore not restricted to the description, but defined by the claims. For example, embodiments with more than two dividing walls and more than three winding chambers or no dividing wall at all are also conceivable. Similarly, more than one main winding and more than two ancillary windings are conceivable. Furthermore, round, oval or rectangular leg cross-sections of the core are possible.

1-19. (canceled)

20. Swinging choke with:
a winding body;
a core that is integrated into the winding body such that at least one air gap is formed in the winding body by the core;
at least one main winding wound onto the winding body wherein the main winding is designed for a high voltage; and
at least one ancillary winding the number of turns of which is designed such that a low voltage can be tapped and which is arranged over the air gap.

21. Swinging choke according to claim 20, wherein the ancillary winding is wound over the main winding at least partially.

22. Swinging choke according to claim 20, wherein the winding body is subdivided into at least two winding chambers,
wherein the at least one main winding is subdivided by the at least two winding chambers into a first partial main winding and a second partial main winding, and wherein
the at least one ancillary winding is wound over the main winding in at least one winding chamber.

23. Swinging choke according to claim 20, wherein the core comprises at least two partial cores, wherein each partial core of the two-part core comprises an E-shaped cross-section with two external legs of the same length, namely a first length, and a somewhat shorter central leg of a second length, and wherein the two-part core is integrated into the winding body, such that the assembled double-E-core forms the air gap between the central legs of the partial cores, when the front faces have a balance distance from opposite external legs.

24. Swinging choke according to claim 22, wherein the winding body comprises a dividing wall which subdivides the winding body into two winding chambers, wherein the dividing wall is arranged along the air gap so as to surround the same.

25. Swinging choke according to claim 24, wherein the ancillary winding is wound over the main winding in the first half of the winding chamber on the side facing the dividing wall.

26. Swinging choke according to claim 25, wherein the ancillary winding is wound over the main winding in the first third of the winding chamber on the side facing the dividing wall.

27. Swinging choke according to claim 25, wherein the ancillary winding is wound over the main winding in the first fourth of the winding chamber on the side facing the dividing wall.

28. Swinging choke according to claim 25, wherein the ancillary winding is wound over the main winding in the first eighth of the winding chamber on the side facing the dividing wall.

29. Swinging choke according to claim 22, wherein the winding body comprises two dividing walls which subdivide the winding body into three winding chambers, wherein the central winding chamber is arranged along the air gap.

30. Swinging choke according to claim 29, wherein the ancillary winding is arranged in the central winding chamber along the air gap.

31. Swinging choke according to claim 20, wherein the ancillary winding only comprises one to five windings.

32. Swinging choke according to claim 20, wherein two ancillary windings are formed which are arranged so as to be as symmetrical as possible to the air gap.

33. Swinging choke according to claim 20, wherein the thickness of the air gap is 1.4 mm.

34. Swinging choke according to claim 20, wherein the dividing wall comprises a thickness of 1.5 mm.

35. Swinging choke according to claim 20, which is designed such that the main winding can be used for driving a lamp, and the tapped voltage can be used by the ancillary winding for heating lamp elements.

36. Swinging choke according to claim 35, wherein the lamp is a fluorescent tube or a gas discharge lamp.

37. Swinging choke according to claim 35, wherein the voltage tapped by the ancillary winding can be used for heating at least one electrode of the lamp.

38. Driver for a lamp with a swinging choke; said swinging choke comprising:
a winding body;
a core that is integrated into the winding body such that at least one air gap is formed in the winding body by the core;
at least one main winding wound onto the winding body wherein the main winding is designed for a high voltage; and
at least one ancillary winding the number of turns of which is designed such that a low voltage can be tapped and which is arranged over the air gap.
